(19) United States
(12) Patent Application Publication
(10) Pub. No.: US 2026/0288363 A1
(43) Pub. Date: Sep. 24, 2026

(54) SPATIAL PRIORITIZATION FOR MEMORY WRITES

(71) Applicant: SK Hynix NAND Product Solutions Corp. (dba Solidigm), Rancho Cordova, CA (US)

(72) Inventors: Darshan Mallapur Vishwanath, Santa Clara, CA (US); Mohammad Nasim Imtiaz Khan, Rancho Cordova, CA (US); David B. Carlton, Pleasanton, CA (US); Yogesh Wakchaure, Folsom, CA (US)

(21) Appl. No.: 19/085,326

(22) Filed: Mar. 20, 2025

(51) Int. Cl. G06F 3/06

(52) U.S. Cl. CPC G06F 3/0655; G06F 3/0604; G06F 3/0652; G06F 3/0679

(57) ABSTRACT

Methods, devices, and data structures are provided for spatial prioritization of memory writes. A method is performed by a memory device coupled to a host device. The method includes receiving a command to write data to memory of the memory device. The die priority list can be received as a data structure. The method includes inspecting a die priority list for writing the data to the memory, where the memory includes multiple dies, each die of the multiple dies including multiple zones. The die priority list is associated with the multiple dies, and the die priority list is based on a number of empty zones of each die, a number of inactive zones of each die, and a number of program erase (PE) cycles of each die. The method includes writing the data to at least one zone of the memory based on the die priority list.

### TECHNICAL FIELD

The present disclosure is directed to methods and devices for writing data to memory.

### BACKGROUND

Data may be written to a memory device in any suitable manner. How the data is written affects the performance of the memory device.

### SUMMARY

Zoned Namespace (ZNS) is an emerging memory architecture, e.g., that can be implemented in solid state drive (SSD) memory devices. In a ZNS architecture, groups of logical block addresses (LBAs) are arranged as zones and managed to increase performance and longevity of the device. Each zone may correspond to one (or more) planar erase block (EB), or possibly to a fraction thereof. In some embodiments, there may be a randomized process for selecting which zones to write data to and to erase data from, creating the potential for a relatively wide distribution of program erase (PE) cycle counts across respective zones. Such a distribution could limit the longevity of a memory device due to degradation of the zones with relatively high EC counts. Moreover, randomized zone selection may not maximize the opportunities for parallel writing, e.g., across multiple dies of the memory device. In accordance with some embodiments of the present disclosure, particular zones and dies are prioritized to be selected for memory writes. A die priority list (or similarly, a plane priority list) is determined based on a number of empty zones, a number of inactive zones, and PE cycle counts of each die (or plane). The die priority list (and optionally the plane priority list) is stored in memory and indicates an order for selecting where to write data in response to receiving a write request. A memory device causes data of the write request to be written to particular dies (and optionally particular planes) based on the priority list.

In accordance with some embodiments of the present disclosure, methods, devices, and data structures are provided for spatial prioritization of memory writes. A method is performed by a memory device including memory, where the memory device is coupled to a host device.

The method includes receiving a command to write data to the memory device. The method includes inspecting a die priority list (e.g., a data structure) for writing the data to the memory, where the memory includes multiple dies, each die of the multiple dies including multiple zones. The die priority list is associated with the multiple dies, and the die priority list is based on a number of empty zones of each die, a number of inactive zones of each die, and a number of program erase (PE) cycles of each die. The method includes writing the data to at least one zone of the zones of the memory based on the die priority list.

In some embodiments, die priority list being based on the number of empty zones of each die includes normalizing the number of empty zones based on a number of total zones of each die.

In some embodiments, the die priority list being based on the number of inactive zones of each die includes determining a number of active zones of each die, determining the number of inactive zones based on a difference between a number of total zones of each die and the number of active zones, and normalizing the number of inactive zones based on the number of total zones of each die.

In some embodiments, the die priority list being based on the number of PE cycles of each die includes normalizing a difference between a maximum number of PE cycles of each die and a number of completed PE cycles of each die based on the maximum number of PE cycles of each die.

In some embodiments, each die of the multiple dies further multiple planes, the method further including, for at least one die of the multiple dies, receiving a plane priority list for writing the data to at least one plane of the multiple planes, each of the at least one plane including multiple zones, and writing the data to at least one zone of the multiple zones of the memory further based on the plane priority list.

In some embodiments, the plane priority list is based on a number of empty zones of each plane, a number of inactive zones of each plane, and a number of program erase (PE) cycles of each plane.

In some embodiments, the method also includes storing the die priority list in memory, and in response to receiving the write command, inspecting the die priority list to cause the data to be written to the memory based on the die priority list.

In some embodiments, the method also includes determining the die priority list by identifying an availability of computational bandwidth of the memory device, and determining the die priority list using the availability of computational bandwidth.

In some embodiments, each zone includes a planar erase block.

In some embodiments, writing the data to the at least one zone of the multiple zones of the memory based on the die priority list includes determining a number of dies that are needed for storing the data, and selecting the number of dies from the multiple dies according to a top of the die priority list.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive. In the drawings:

FIG. 1 shows an illustrative memory device for writing data to memory based on a priority list in accordance with some embodiments of the present disclosure;

FIG. 2 shows an illustrative sequence of writing data to zones of a memory device in accordance with some embodiments of the present disclosure;

FIG. 3 shows illustrative equations for determining the merit of a physical memory area in accordance with some embodiments of the present disclosure;

FIG. 4 shows an illustrative die priority list in accordance with some embodiments of the present disclosure;

FIG. 5 shows an illustrative plane priority list in accordance with some embodiments of the present disclosure; and

FIG. 6 shows a flowchart of an illustrative process for writing data to memory based on a die priority list.

### DETAILED DESCRIPTION

In accordance with the present disclosure, devices and methods for writing data to at least one zone of a ZNS architecture, where the zone is selected based on a priority list (e.g., a die priority list, zone priority list, any other priority list, or any combination thereof) are provided to improve memory device performance, e.g., based at least on parallelization of write operations or making program erase (PE) cycle distributions more uniform.

As mentioned above, a zoned namespace (ZNS) architecture may be used to group logical block addresses (LBAs) of a memory device (e.g., including an SSD) and to manage the memory device for increased performance and longevity. Each zone of the ZNS may align with a physical erase block (EB) of the memory. That is, a zone may be a single EB, or a zone may include multiple EBs. The ZNS approach may serve to minimize background defragmentation activity of the memory. When implementing the ZNS architecture, the processes of writing data to the memory device and erasing data from the memory device may be managed on a zonal basis. That is, write and/or erase operations may occur on the granularity of a single zone (or a multiple thereof).

In some embodiments, the memory of the device disclosed herein may contain any of the following memory densities: single-level cells (SLCs), multi-level cells (MLCs), triple-level cells (TLCs), quad-level cells (QLCs), penta-level cells (PLCs), and any suitable memory density that is greater than five bits per memory cell.

In some embodiments, a memory or host device may randomly select respective zones to write to during a write sequence, and may randomly select respective zones to erase from during an erase sequence. Alternatively, the memory or host device may select the zones storing the oldest memory to erase from and to write to. Either of these approaches could be suboptimal due to possibly creating a large distribution of PE cycle counts across respective zones and further due to not prioritizing parallelized writing operations (e.g. across multiple dies of the memory device). To maximize memory device performance, write operations should be parallelized as much as possible, and the distribution of PE cycles across physical portions of the memory should be as narrow as possible.

In accordance with some embodiments of the present disclosure, a priority list (e.g., which may be a die priority list or a plane priority list, or which may include both die and plane priorities) is determined by tracking various parameters during operation of the memory device. These tracked parameters (e.g., of a die or plane) include at least a number of empty zones, a number of inactive zones, and a number of PE cycles. The priority list includes a prioritized order of physical locations to which data should be written. The priority list can be determined (e.g., by processing circuitry of a memory device) based on the write request, or it can be determined ahead of time (e.g., using an availability of computational bandwidth) and stored in memory.

In response to receiving a write request, the priority list is inspected. Based on inspection of the priority list, the memory device writes data of the write request to the highest-priority locations (e.g., the dies, planes, zones, decks, and/or EBs at the top of the list). In some embodiments, the memory device further writes data of the write request based on another priority to parallelize operations (e.g., across multiple dies).

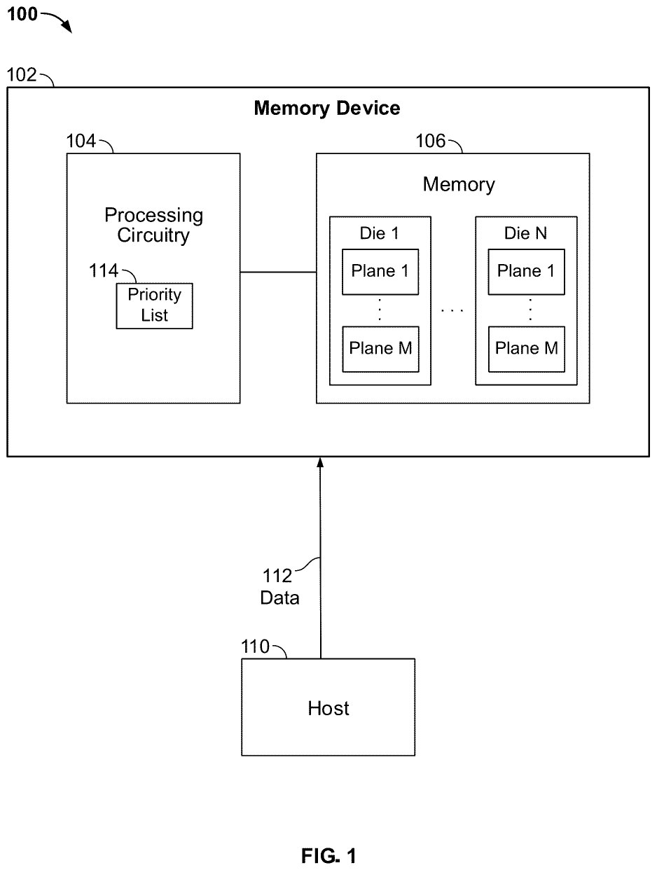

The subject matter of this disclosure is further discussed with reference to FIGS. 1-6.

FIG. 1 shows an illustrative memory device 102 for writing data 112 to memory 106 based on a priority list determined at processing circuitry 104 in accordance with some embodiments of the present disclosure. Memory device 102 may be communicatively coupled to host device 110. Memory device 102 includes processing circuitry 104 and memory 106, where processing circuitry 104 is coupled to memory 106. Processing circuitry 104 can inspect priority list 114 to write to (or to cause data to be written to) correspondingly prioritized locations of memory 106. Memory 106 may include multiple respective dies (e.g., Die 1 through Die N, where N is any suitable integer), each die including multiple respective (e.g., Plane 1 through Plane M, where M is any suitable integer).

Host device 110 may be coupled to memory device 102 and may be configured to provide data 112 to memory device 102, as shown. Data 112 may include data to be written to memory device 102, as well as write, read, and erase commands.

In some embodiments, the processing circuitry 104 is configured to receive requests from host device 110, where each request includes a memory address (e.g., indicating a die, zone, LBA, other physical location, or any combination thereof) of memory 106. The request received by the processing circuitry 104 may be a read request or a write request, where the host device 110 requests access to the corresponding memory address included in the request (e.g., to read data from or to write data to the memory address). In some embodiments, the memory address included in the request is a memory address of non-volatile memory of the memory 106. In some embodiments, the request is transmitted on a network bus or interface to the processing circuitry 106. In some embodiments, the request is transmitted from an external source (e.g., the host device 110 that is communicatively coupled to the memory device 102). The processing circuitry 104 may receive requests from both internal and external sources of the memory device 102. In some embodiments, the memory device 102 includes volatile memory, which is configured to temporarily store any outstanding requests that are to be processed by the processing circuitry 104.

Processing circuitry 104 is configured to track parameters of memory 106, as described above and as further described below. Priority list 114 may be determined based on those tracked parameters (e.g., including but not limited to a number of empty zones, a number of inactive zones, and a number of PE cycles). Processing circuitry may be configured to determine die priority list 114 based on there being an availability of computational bandwidth (e.g., at memory device 102). That is, one or more priority lists 114 may be proactively determined at a time that does not interrupt operations of memory device 102 and/or host device 110. Any proactively determined priority list 114 may be stored in memory 106, e.g., to be retrieved and inspected in response to a write command being received.

Priority list 114 includes at least a prioritization of dies (e.g., a ranked list of Dies 1 through N based on a respective merit of each die, as further described below). Priority list 114 may also include (e.g., as a separate list of multiple priority lists, or as an integrated list) a prioritization of planes (e.g., a ranked list of Planes 1 through M based on a respective merit of each plane, as further described below). In some embodiments, each plane may include multiple decks (which may include multiple EBs), or each plane may include multiple EBs. As such, priority list 114 may also include a prioritization of decks and/or EBs. A ZNS architecture may allocate zones according to respective EBs, respective decks, respective planes, or any other respective unit of physical memory. Some embodiments of this disclosure may apply to any mapping of physical memory to zones, irrespective of the physical sizes of those zones.

For purposes of brevity and clarity, the features of the disclosure described herein are in the context of a device (e.g., an SSD device) having processing circuitry and memory. However, the principles of the present disclosure may be applied to any other suitable context in which memory is managed based on a ZNS architecture. The device may include processing circuitry and memory communicatively coupled to each other by a network bus or interface.

In some embodiments, a processor of the processing circuitry may be a highly parallelized processor capable of handling high bandwidths of incoming data quickly (e.g., by starting simultaneous processing of requests or instructions before completion of previously received requests or instructions). In some embodiments, one or more trained models (e.g., neural networks) can be implemented using the processing circuitry, e.g., to generate any priority list described in this disclosure.

In some embodiments, the devices and methods of the present disclosure may refer to a memory device (e.g., an SSD storage device), which includes memory device memory such as solid-state drive device memory, which is communicatively coupled to the processing circuitry by a network bus or other suitable interface.

In some embodiments, memory device 102 is an SSD on which a ZNS architecture has been implemented. The SSD is a data storage device that uses integrated circuit assemblies as memory to store data persistently. The SSD may use multiple semiconductor cells arranged in an array to persistently store data. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency.

Many types of memory devices, including many types of SSDs, use NAND-based flash memory which retains data without power and includes a type of non-volatile storage technology. Quality of Service (QOS) of a memory device may be related to the predictability of low latency and consistency of high input/output operations per second (IOPS) while servicing read/write input/output (I/O) workloads. This means that the latency or the I/O command completion time needs to be within a specified range without having unexpected outliers. The throughput or I/O rate may also need to be tightly regulated without causing sudden drops in performance levels. QoS may also be related to the extent to which operations of the memory device are parallelized. QoS may also be related to the uniformity of a PE cycle distribution across regions of memory of a memory device.

Memory 106 of memory device 102 may include persistent storage media. The persistent storage media of the device may be referred to as the main memory of the device. In some embodiments, the persistent storage media includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, the persistent storage media includes memory of a memory density, the memory density is any one of (a) single-level cell (SLC) memory density, (b) multi-level cell (MLC) memory density, (c) tri-level cell (TLC) memory density, (d) quad-level cell (QLC) memory density, (e) penta-level cell (PLC) memory density, or (f) a memory density of greater than 5 bits per memory cell. Processing circuitry 104 is communicatively coupled to memory 106 to store and access data in memory blocks, pages, and/or zones of memory 106. In some embodiments, a data bus interface is used to transport data transfer requests or data. In some embodiments, the data bus interface includes a data transfer request bus and a data interface (e.g., for transferring data 112 to or from host 110). In some embodiments, memory 106 includes multiple memory dies. In some embodiments, memory 106 includes multiple bands of memory, each band spanning across each memory die. In some embodiments, memory 106 may be accessed (e.g., read or written to) using direct memory access (DMA) by the processing circuitry 104. In such embodiments, the processing circuitry 104 includes a processor to fetch and execute commands, and a memory controller (e.g., a DMA controller) to process and perform DMA transfers independent of the execution of instructions by the processor.

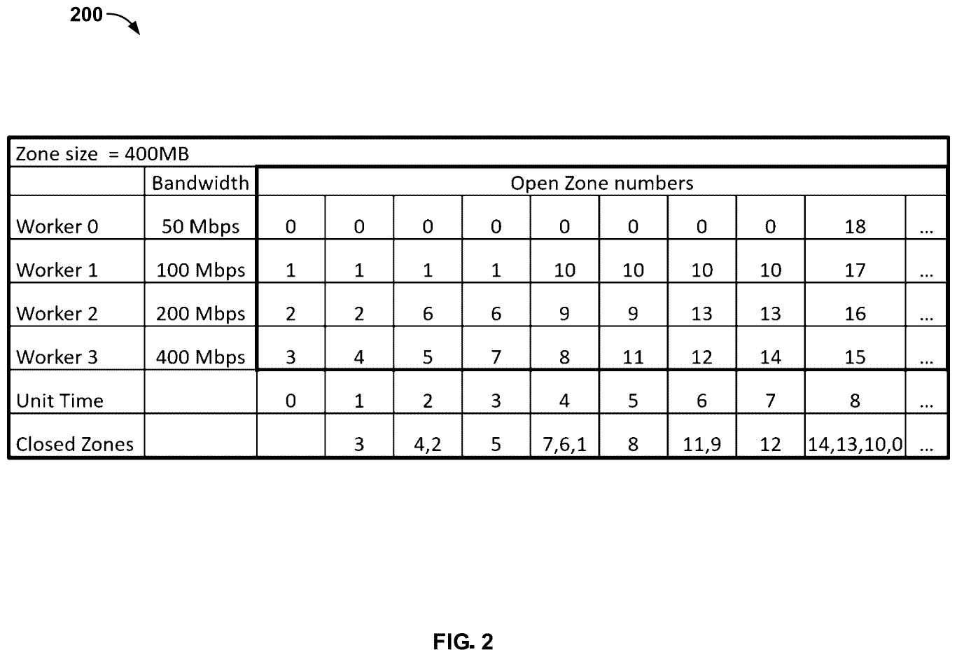

FIG. 2 shows an illustrative sequence 200 of writing data to zones of a memory device (e.g., memory device 102) in accordance with some embodiments of the present disclosure. In the illustrative sequence 200, each zone covers 400 MB of memory and there are four workers (i.e., workers 0-3) writing data to open zones, each working having a respective bandwidth, as shown. The illustrative sequence 200 represents writing data to zones of a memory device based on the zone number, rather than based on a priority list or a figure of merit.

At “Unit Time” 0 of FIG. 2 (e.g., an initial time associated with a write sequence), worker 0 begins writing to zone 0, working 1 begins writing to zone 1, worker 2 begins writing to zone 2, and worker 3 begins writing to zone 3, as indicated by the “Open Zone Numbers”.

Because of the different write bandwidths, worker 0 takes eight time intervals to fill up zone 0, worker 1 takes four time intervals to fill up zone 1, worker 2 takes two time intervals to fill up zone 2, and worker 3 takes one time interval to fill up zone 3, as indicated by the number of repetitions of each open zone number in a row. At Unit Time 1, worker 3 is commanded to write to a new zone, and zone 4 is selected as that new zone because the write sequence is ordered by zone number. Moreover, zone 3 is added to the “Closed Zones” list, as shown in the bottom row of FIG. 2. The write sequence continues as described, with each open zone being added to the “Closed Zones” list after it has been written to, and with each worker writing to a new zone based on the lowest open zone number. If all open zones were to fill up, illustrative sequence 200 would continue by writing data to the oldest available zones. That is, zones 3, 4, and 2, in that order, would be the first zones erased and rewritten to (as per the Closed Zones list) if all open zones were occupied and additional data needed to be written.

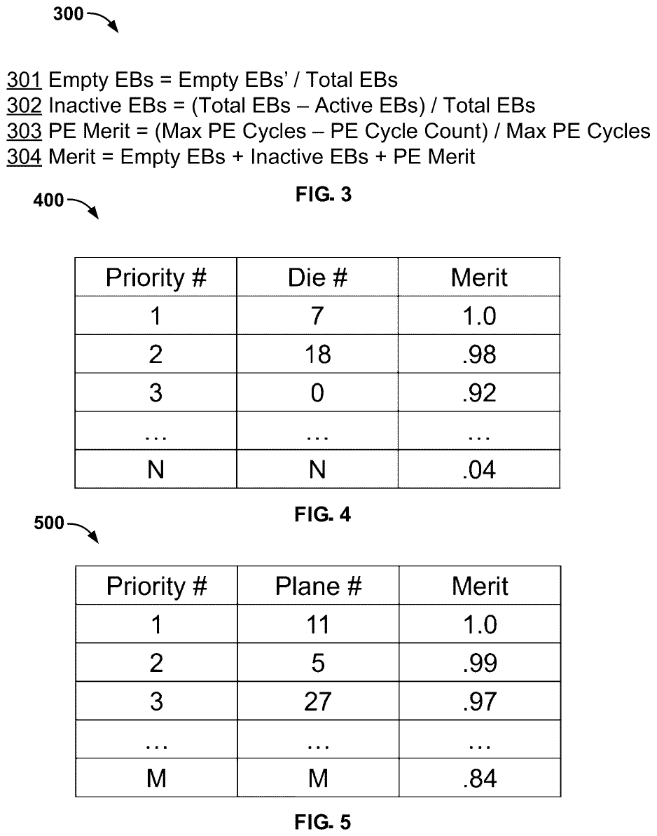

FIG. 3 shows illustrative equations 300 for determining the merit of a physical memory area in accordance with some embodiments of the present disclosure. Merit equation 304 is based on empty EBs equation 301, inactive EBs equation 302, and PE merit equation 303. The merit value of merit equation 304 is used to rank physical areas of memory in a priority list (e.g., priority list 114). Illustrative equations 300 may be applied to dies, planes, decks, EB groups, zones, or any other suitable physical memory unit size. Each of Equations 301, 302, and 303 yields a normalized value (i.e., between 0 and 1). As a result, illustrative equations 300 may be agnostic to the size of the physical memory unit for which a priority list is being determined.

Equation 301 quantifies the normalized number of empty EBs (i.e., Empty EBs) in the physical memory unit. In particular, the number of empty EBs (i.e., Empty EBs', where the apostrophe is used to represent a non-normalized value) in the physical memory unit are divided by the total number of EBs (i.e., Total EBs) in the physical memory unit. That is, a physical memory unit that is completely empty would be assigned a 1, a physical memory unit that is completely filled would be assigned a 0, a physical memory unit that is half filled would be assigned a 0.5, and so on.

Equation 302 quantifies the normalized number of inactive EBs (i.e., Inactive EBs) in the physical memory unit. In particular, the number of active EBs (i.e., Active EBs) in the physical memory unit is subtracted from the total number of EBs (i.e., Total EBs) in the physical memory unit, and that subtracted value is divided by the total number of EBs in the physical memory unit. As used herein, an active EB may be any EB that is currently being written to, or that is expected to be written to soon (e.g., there is a queued command, or other aspect of an ongoing write sequence, for which the EB is allocated). That is, a physical memory unit that is completely empty and inactive would be assigned a 1, a physical memory unit that is entirely filled with active EBs would be assigned a 0, a physical memory unit that is half filled with active EBs and half filled with empty EBs would be assigned a 0.5, and so on.

Equation 303 quantifies the normalized PE history (i.e., PE Merit) of the physical memory unit. In particular, the number of PE cycles (i.e., PE Cycle Count) of the physical memory unit is subtracted from a maximum number of PE cycles (i.e., Max PE Cycles) of the physical memory unit, and that subtracted value is divided by the maximum number of PE cycles of the physical memory unit. That is, a physical memory unit that is completely empty would be assigned a 1, a physical memory unit that is completely filled would be assigned a 0, a physical memory unit that is half filled would be assigned a 0.5, and so on.

Equation 304 quantifies a merit (i.e., Merit) as the sum of the normalized parameters calculated using Equations 301, 302, and 303. That is, the merit is equal to the normalized number of empty EBs, plus the normalized number of inactive EBs, plus the normalized PE history, as shown. The merit value is bounded by 0 and 3, with values close to the former corresponding to lower priority physical memory units and with values close to the latter corresponding to higher priority physical memory units.

In some embodiments, after quantifying the normalized number of empty EBs, there is a determination of whether the normalized number of empty EBs is zero. If the number of normalized number of empty EBs is zero, then the merit is assigned as zero (i.e., calculation of equations 302, 303, and 304 may be skipped); otherwise, equations 302, 303, and 304 are calculated as shown.

FIG. 4 shows an illustrative die priority list 400 (e.g., a data structure for spatial prioritization for memory writes) in accordance with some embodiments of the present disclosure. The priority number column of FIG. 4 ranks the dies according to the order by which a write sequence should write data to the dies. The die number column of FIG. 4 shows how the priority need not correspond to an order by which the dies are physically arranged within a memory device. The merit column of FIG. 4 shows merit scores for each die, e.g., as calculated using the equations of FIG. 3. The dies are ranked from highest to lowest merit score, and the placement of each die on that ranked list determines its priority number.

FIG. 5 shows an illustrative plane priority list (e.g., a data structure for spatial prioritization for memory writes) accordance with some embodiments of the present disclosure. For example, the plane priority list may correspond to planes of Die 0, as shown in FIG. 5. The priority number column of FIG. 5 ranks the planes according to the order by which a write sequence should write data to the planes. The plane number column of FIG. 5 shows how the priority need not correspond to an order by which the planes are physically arranged within a die. The merit column of FIG. 5 shows merit scores for each plane, e.g., as calculated using the equations of FIG. 3. The planes are ranked from highest to lowest merit score, and the placement of each plane on that ranked list determines its priority number.

In some embodiments, the dies of FIG. 4 may correspond to Dies 1 through N of memory 106. The Planes 1 through M may correspond to any one of the Dies 1 through N, or to any other suitable die.

As mentioned, the die priority list 400 or the plane priority list 500 may be adapted for any other suitable unit size of memory. For example, there could be a zone priority list, a deck priority list, an EB priority list, or a priority list based on any other memory granularity. For any such priority list, the equations of FIG. 3 can be applied by analyzing EBs of the corresponding memory granularity to determine a corresponding priority list. Moreover, all merit values shown in FIGS. 4-5 are merely illustrative; indeed, the highest merit value of a priority list can be any value between 0 and 1, as can the lowest merit value of a priority list (provided that the lowest merit value is less than the highest merit value).

In some embodiments, priority lists may be nested according to granularity size. For example, there may be one die priority list 400 and multiple plane priority lists 500, each plane priority 500 corresponding to a respective die of the die priority list 400. During a write sequence incorporating spatial prioritization, processing circuitry 104 may first inspect die priority list 400 to select at least one die, and may then inspect the corresponding at least one plane priority list 500 to select at least one plane for each of the selected at least one die. The nesting could continue (e.g., in one or more nested lists) onto the granularity of deck size, zone size, EB size, or other suitable granularity.

In some embodiments, a single priority list may list priorities for dies and planes, or for any other at least two granularities. For example, such a priority list may, for each die, include rows corresponding to every plane of the die (or every plane above a certain merit) before listing a next priority die. For another example, such a priority list may simply rank all possible planes, along with the corresponding dies, according to the respective plane merit scores.

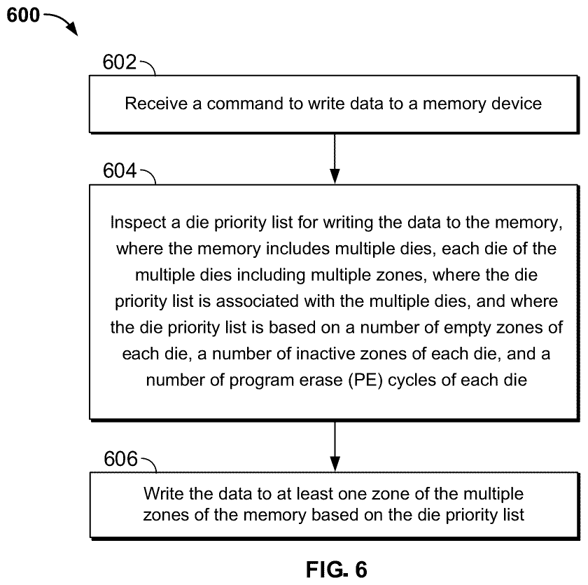

FIG. 6 shows a flowchart of an illustrative process 600 for writing data to memory based on a die priority list. For example, illustrative process 600 may be executed by memory device 102 based on inspection of a priority list 114 (e.g., die priority list 400, plane priority list 500, any other priority list, or any combination thereof). That inspected priority list may be determined by memory device 102 (e.g., by processing circuitry 104). Determining the priority list may include generating the priority list directly in response to receiving a write command, or it may include retrieving the priority list in response to receiving the write command, where the priority list was generated prior to receiving the write command (e.g., when there was an availability of computational memory) and was then stored in memory 106 to be available when a write command is received.

At step 602, a command is received (e.g., by processing circuitry 104 of memory device 102) to write data to a memory device. The command may be sent by host device 110.

At step 604, a die priority list (e.g., die priority list 400) is inspected for writing the data to the memory (e.g., memory 106). The memory includes multiple dies (e.g., Dies 1 through N, as shown in FIG. 1), each die of the multiple dies including multiple zones. Each of those zones could be a plane (e.g., one of Planes 1 through M, as shown in FIG. 1), could be multiple planes, or could be a fraction of a plane (e.g., a single EB, or multiple EBs). The die priority list is associated with the multiple dies. The die priority list is based on a number of empty zones of each die, a number of inactive zones of each die, and a number of PE cycles of each die. For example, determining the die priority list may include the use of equations 300.

At step 606, the data is written to at least one zone of the multiple zones of the memory based on the die priority list. For example, if writing the data requires writing to three respective dies, then those three dies will be selected based on the top three dies of the die priority list.

In some embodiments, illustrative process 600 also includes inspecting a plane priority list (e.g., plane priority list 500) and writing the data to the memory further based on the plane priority list. For example, if writing the data requires writing to three respective planes of a die, then those three planes will be selected based on the top three planes of the plane priority list.

In some embodiments, a modified process that is related to illustrative process 600 may be performed (e.g., by host device 110, or any other device communicatively coupled to a memory device). That modified process modifies step 604 to include determining (rather than inspecting) the die priority list, and to further include sending the die priority list to a memory device. That modified process modifies step 606 to include causing (rather than writing) cause the data to be written to at least one zone of the multiple zones of the memory of the memory device.

In some embodiments, illustrative process 600 also includes tracking parameters (e.g., those parameters used in equations 300) of the memory device, where the tracked parameters include at least the number of empty zones, the number of inactive zones, and the number of PE cycles.

In some embodiments, illustrative process 600 also includes determining the die priority list (e.g., calculating respective merits based on equations 300). The priority list may be determined by processing circuitry 106 based on generating priority list 114, or based on retrieving priority list 114 from memory 106. In some embodiments, determining the die priority list includes identifying an availability of computational bandwidth (e.g., of memory device 102) and determining the die priority list (e.g., executing the calculations of equations 300) using the availability of computational bandwidth.

In some embodiments, wherein writing the data to the at least one zone of the plurality of zones of the memory based on the die priority list includes determining a number of dies that are needed for storing the data, and selecting the number of dies from the plurality of dies according to a top of the die priority list. In some embodiments, determining the number of dies includes determining at least two dies based on an additional priority to parallelize the writing.

Thus it has been shown that systems and methods are provided for spatial prioritization for memory writes.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method performed by a memory device comprising memory, the memory device coupled to a host device, the method comprising:
receiving a command to write data the memory device;
inspecting a die priority list for writing the data to the memory, wherein the memory comprises a plurality of dies, each die of the plurality of dies comprising a plurality of zones, wherein the die priority list is associated with the plurality of dies, and wherein the die priority list is based on:
a number of empty zones of each die,
a number of inactive zones of each die, and
a number of program erase (PE) cycles of each die; and
writing the data to at least one zone of the plurality of zones of the memory based on the die priority list.

2. The method of claim 1, wherein the die priority list being based on the number of empty zones of each die comprises:
normalizing the number of empty zones based on a number of total zones of each die.

3. The method of claim 1, wherein the die priority list being based on the number of inactive zones of each die comprises:
determining a number of active zones of each die;
determining the number of inactive zones based on a difference between a number of total zones of each die and the number of active zones; and
normalizing the number of inactive zones based on the number of total zones of each die.

4. The method of claim 1, wherein the die priority list being based on the number of PE cycles of each die comprises:
normalizing a difference between a maximum number of PE cycles of each die and a number of completed PE cycles of each die based on the maximum number of PE cycles of each die.

5. The method of claim 1, wherein each die of the plurality of dies further comprises a plurality of planes, the method further comprising, for at least one die of the plurality of dies:
inspecting a plane priority list for writing the data to at least one plane of the plurality of planes, each of the at least one plane comprising a plurality of zones; and
writing the data to at least one zone of the plurality of zones of the memory further based on the plane priority list.

6. The method of claim 5, wherein the plane priority list is based on:
a number of empty zones of each plane,
a number of inactive zones of each plane, and
a number of program erase (PE) cycles of each plane.

7. The method of claim 1, further comprising:
storing the die priority list in memory; and
in response to receiving the write command, inspecting the die priority list to cause the data to be written to the memory based on the die priority list.

8. The method of claim 1, further comprising determining the die priority list by:
identifying an availability of computational bandwidth of the memory device; and
determining the die priority list using the availability of computational bandwidth.

9. The method of claim 1, wherein each zone comprises a planar erase block.

10. The method of claim 1, wherein writing the data to the at least one zone of the plurality of zones of the memory based on the die priority list comprises:
determining a number of dies that are needed for storing the data; and
selecting the number of dies from the plurality of dies according to a top of the die priority list.

11. A memory device comprising:
memory comprising a plurality of dies, each die of the plurality of dies comprising a plurality of zones; and
processing circuitry to:
receive a command to write data to the memory,
inspect a die priority list for writing data to the memory, wherein the die priority list is based on:
a number of empty zones of each die;
a number of inactive zones of each die; and
a number of program erase (PE) cycles of each die, and
write the data to at least one zone of the plurality of zones of the memory based on the die priority list.

12. The memory device of claim 11, wherein the die priority list is based on the number of empty zones of each die by normalizing the number of empty zones based on a number of total zones of each die.

13. The memory device of claim 11, wherein the die priority list is based on the number of inactive zones of each die by:
determining a number of active zones of each die;
determining the number of inactive zones based on a difference between a number of total zones of each die and the number of active zones; and
normalizing the number of inactive zones based on the number of total zones of each die.

14. The memory device of claim 11, wherein the die priority list is based on the number of PE cycles of each die by normalizing a difference between a maximum number of PE cycles of each die and a number of completed PE cycles of each die based on the maximum number of PE cycles of each die.

15. The memory device of claim 11, wherein each die of the plurality of dies further comprises a plurality of planes, and the processing circuitry is further to, for at least one die of the plurality of dies:
inspect a plane priority list for writing the data to at least one plane of the plurality of planes, each of the at least one plane comprising a plurality of zones; and
write the data to at least one zone of the plurality of zones of the memory further based on the plane priority list.

16. The memory device of claim 15, wherein the plane priority list is based on:
a number of empty zones of each plane,
a number of inactive zones of each plane, and
a number of program erase (PE) cycles of each plane.

17. The memory device of claim 11, wherein the processing circuitry is further to:
store the die priority list in memory; and
in response to receiving a write command, inspect the die priority list to write the data to the at least one zone of the plurality of zones of the memory based on the die priority list.

18. The memory device of claim 11, wherein the processing circuitry is further to determine the die priority list by:
identifying an availability of computational bandwidth of the memory device; and
determining the die priority list using the availability of computational bandwidth.

19. The memory device of claim 11, wherein each zone comprises a planar erase block.

20. A data structure for writing data to memory comprising a plurality of dies, each die of the plurality of dies comprising a plurality of zones, the data structure comprising:
a die priority list based on:
a number of empty zones of each die,
a number of inactive zones of each die, and
a number of program erase (PE) cycles of each die;
wherein data is to be written to at least one zone of the plurality of zones of the memory based on the die priority list.
